(19) United States
(12) Patent Application Publication
(10) Pub. No.: US 2014/0342464 A1
(43) Pub. Date: Nov. 20, 2014

(54) Package Including an Anti-Counterfeit Indicator

(71) Applicant: Scott Cooper, Perrysburg, OH (US)

(72) Inventor: Scott Cooper, Perrysburg, OH (US)

(21) Appl. No.: 13/897,782

(22) Filed: May 20, 2013

(51) Int. Cl. G01N 21/78

(52) U.S. Cl. CPC G01N 21/78
USPC 436/164; 422/400

(57) ABSTRACT

A package including a container and an anti-counterfeit indicator that can indicate whether or not a product dispensably disposed within the container is authentic or counterfeit when it is exposed to a sample of the product. The indicator may be configured to produce a response upon detecting a certain chemical compound in the product that is indicative of the authenticity of the product.

The present disclosure is directed to containers and, more particularly, to containers having anti-counterfeit features.

### BACKGROUND AND SUMMARY OF THE DISCLOSURE

Many containers are provided with invisible or transparent markings or codes, which can be rendered visible by various methods to indicate whether the container and its contents are authentic or counterfeit. For example, a container may be formed with indicia embedded therein or coated thereon that can distinguish the container from other counterfeit containers. U.S. Pat. No. 4,143,380 illustrates containers having markings of this type.

A general object of the present disclosure, in accordance with one aspect of the disclosure, is to provide a package including a container and an anti-counterfeit indicator, and a method of determining whether a product dispensably disposed within the container is authentic or counterfeit.

The present disclosure embodies a number of aspects that can be implemented separately from or in combination with each other.

A package, in accordance with one aspect of the disclosure, includes a container, a product dispensably disposed within the container, a closure for the container, and an indicator carried by the container, the closure, or both the container and the closure. The indicator indicates whether or not the product within the container is authentic or counterfeit when it is exposed to a sample of the product.

In accordance with another aspect of the disclosure, there is provided a method of authenticating a product dispensably disposed within a container that includes: (a) identifying a chemical compound associated with an authentic product, (b) providing a sample of the product to be authenticated, (c) exposing an indicator to the sample of the product, (d) detecting the presence of the chemical compound in the sample, and (e) observing a response produced by the indicator.

In accordance with yet another aspect of the disclosure, there is provided a method of determining whether a product dispensably disposed within a container is authentic or counterfeit that includes: (a) removing a sample of the product from the container, (b) applying the sample to a surface of the container or to a surface of a closure for the container, and (c) detecting a chemical compound in the sample that is associated with an authentic product.

### BRIEF DESCRIPTION OF THE DRAWINGS

The disclosure, together with additional objects, features, advantages and aspects thereof, will be best understood from the following description, the appended claims and the accompanying drawings, in which:

FIG. 1 is a side elevation of a package, in accordance with an illustrative embodiment of the present disclosure, that includes a container having a product dispensably disposed therein and an anti-counterfeit indicator carried by an external surface of the container;

FIG. 2 is a schematic illustration of an anti-counterfeit indicator, in accordance with an illustrative embodiment of the present disclosure, that includes a plurality of individual spaced-apart reagent-containing regions;

FIG. 3A is a schematic illustration of the anti-counterfeit indicator of FIG. 2 after exposure to a authentic product;

FIG. 3B is a schematic illustration of the anti-counterfeit indicator of FIG. 2 after exposure to a counterfeit product;

FIG. 4A is a side view of a portion of a package, in accordance with another illustrative embodiment of the present disclosure, that includes a container and an anti-counterfeit indicator carried by an external surface of the container;

FIG. 4B is a side view of a portion of the package of FIG. 4A illustrating one method of removing the anti-counterfeit indicator from the package;

FIG. 5 is a side view of a portion of a package, in accordance with yet another illustrative embodiment of the present disclosure, that includes a container, a hangtag, and an anti-counterfeit indicator carried by the hangtag;

FIG. 6 is a side view of a portion of a package, in accordance with another embodiment of the present disclosure, that includes a container, a closure for the container, and an anti-counterfeit indicator carried by the closure; and

FIG. 7 is a top view of the closure of FIG. 6.

### DETAILED DESCRIPTION

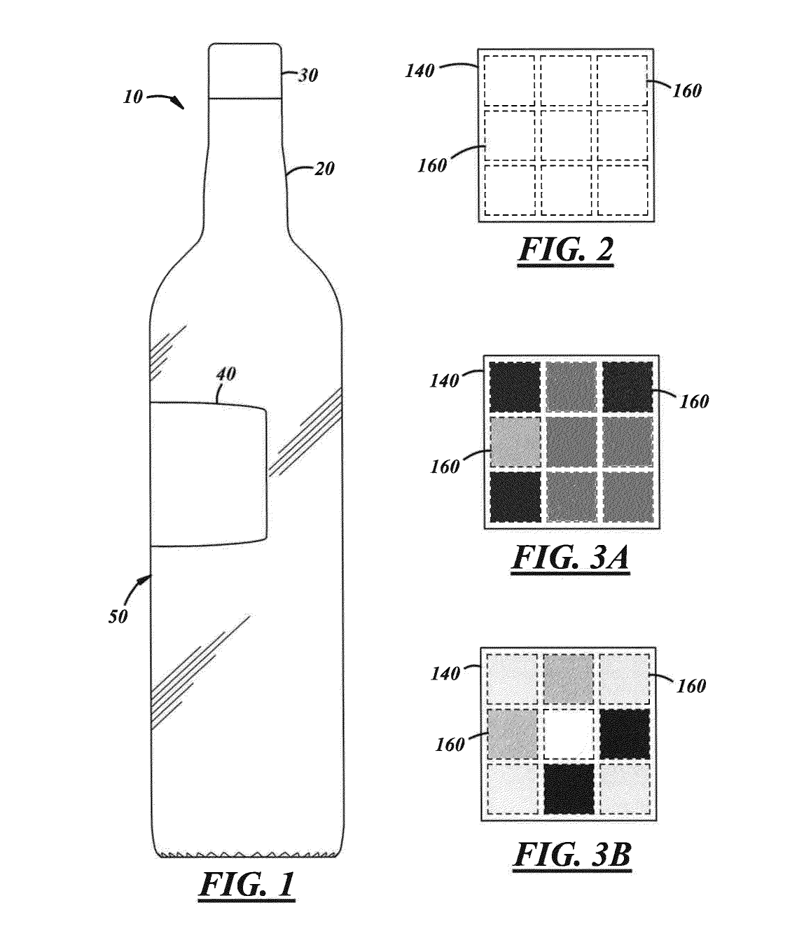

FIG. 1 illustrates a package 10, in accordance with an illustrative embodiment of the present disclosure, that includes a container 20 having a product dispensably disposed therein, a closure 30 for the container 20, and an anti-counterfeit indicator 40 carried by the container 20. However, in other suitable embodiments, the indicator 40 may be carried by the closure 30. As used herein, the phrase “carried by” includes carried in, carried on, coupled to, and/or the like. For example, the anti-counterfeit indicator 40 may be carried by the container 20 or the closure 30 by being attached to an external surface 50 of the container 20 or the closure 30.

When the anti-counterfeit indicator 40 is exposed to a sample of the product within the container 20, the indicator 40 can produce a response that can be used to determine whether or not the product in the container is authentic or counterfeit. The indicator 40 may be exposed to a sample of the product, for example, by wetting the indicator with a sample of the product, or by wiping, dripping, or pouring a sample of the product onto the indicator.

The container 20 may be of any suitable, shape, and may include a jug, jar, bottle, other food or beverage container, or any other suitable container. The container 20 may be of one-piece integrally formed construction, for example, of glass, plastic, or any other suitable material. (The term “integrally formed construction” does not exclude one-piece integrally molded layered glass constructions of the type disclosed for example in U.S. Pat. No. 4,740,401, or one-piece glass bottles to which other structure is added after the bottle-forming operation.) The container 20 may be fabricated in press-and-blow, blow-and-blow, or hand blowing glass container manufacturing operations, or in a plastic injection and/or blow molding operation, or in any other suitable manner. The indicator 40 of the present disclosure may suitably be used with containers that are already in commercial production. That is, the indicator 40 of the present disclosure can be used with a wide variety of containers that are already being manufactured. No new containers and/or molds need to be made in order to use the indicator 40 of the present disclosure.

The closure 30 for the container 20 may include a cap, cork, plug, or any other suitable type of closure, and may be composed of plastic, metal, glass, ceramic, or any other suitable material.

The indicator 40 is configured to produce a response when it detects the presence of a certain substance or chemical compound in the aforementioned product. For example, the indicator 40 may be configured to detect the presence of certain chemical compounds that are known to be associated with authentic products. In such case, a positive response by the indicator 40 would indicate that the product dispensably disposed within the container 20 is authentic, and the absence of a response would indicate that the product is counterfeit. The indicator 40 also may be configured to detect the amount of certain chemical compounds in a product, for example to determine if the amount corresponds to the amount associated with an authentic product.

In another example, a response may be produced when the indicator 40 detects the presence of a certain substance or chemical compound that is known to be associated with a counterfeit product. A chemical compound, or the amount of a chemical compound that is known to be associated with a certain product may be a compound or amount that is normally present, or can be expected to be present, in a product that has been produced by a certain process using certain ingredients. The indicator 40 of the present disclosure can be used to establish the authenticity of products that have not been marked for the purposes of identification or authentication by marker compounds or chemicals that would not normally be present in such products.

The “response” produced by the indicator 40 may include any change that can be observed or detected with or without the use of an instrument. For example, the response produced by the indicator may be one that can be visually observed by a person or can be observed by olfaction. Examples of responses that can be visually observed by a person include colorimetric responses or fluorescence responses. Examples of instruments that may be used to detect a response produced by the indicator 40 include spectrometers, spectrophotometers, colorimeters, tintometers, and fluorometers, to name a few.

In some embodiments, the presence or absence of a response by the indicator 40 will be sufficient to indicate to a person that the product is either authentic or counterfeit. In others, the degree of the response may indicate that the product is authentic or counterfeit. To determine whether or not the product is authentic or counterfeit, the response produced by the indicator 40 may need to be compared to a reference, e.g., a scale, chart, pattern, or the like. In such case, the reference may be provided with the package 10, for example, the reference may be carried by the container 20 and/or by the closure 30. In one specific embodiment, the container 20 may include labels or other surfaces features indicating the response that can be expected to be produced if the product is authentic and/or counterfeit.

The response produced by the indicator 40 may be brought about by one or more reagents that are entrapped or encapsulated within the indicator 40. The term “reagent,” as used herein, refers to any compound or mixture of compounds that is configured to react or interact with a predetermined chemical compound in a product to directly or indirectly produce a response. For example, if a reaction between a reagent and a predetermined chemical compound does not directly produce a response, the reaction between the reagent and the chemical compound may link to another reaction that does produce a response. Suitable reagents for use in the indicator 40 of the present disclosure may include biogenic substances or biomolecules, for example, enzymes, which may or may not be used in combination with dyes and/or fluorescent compounds.

The one or more reagents may be uniformly dispersed throughout the indicator 40, or the reagents may be selectively positioned at different locations within the indicator. For example, the reagents may be arranged such that the response produced by the indicator 40 exhibits a desired shape, pattern, or word.

The indicator 40 may be in the form of a label, coating, or film that is carried by the container 20. For example, the indicator 40 may be in the form of a label, coating, or film that has been applied to or formed on the external surface 50 of the container 20.

Suitable coatings for use in embodiments of the present disclosure include sol-gel coatings, which may or may not include organic functional groups. During the formation of a sol-gel coating, relatively small compounds, like the reagents of the present disclosure, can be entrapped or encapsulated within the porous glass, e.g., silica, matrix of the sol-gel coating. A sol-gel coating may be formed, on the external surface of the container 20 as a unitary film or as a series of specifically arranged “patches,” with each patch including the same or different reagents. A sol-gel coating may be applied to the container 20 by any suitable means, for example, by spin coating or screen-printing methods.

FIGS. 2, 3A, and 3B show another illustrative embodiment of an indicator 140. This embodiment is similar in many respects to the embodiment of FIG. 1, and like numerals among the embodiments generally designate like or corresponding elements throughout the several views of the drawing figures. Accordingly, the descriptions of the embodiments are incorporated into one another, and description of subject matter common to the embodiments generally may not be repeated here.

The indicator 140 includes a plurality of individual reagent-containing regions 160 spaced apart from each other. The regions 160 in the indicator 140 may include some, all, or none of the same reagents. Thus, each region 160 may be configured to produce the same or a different response. Accordingly, the response produced by the indicator 140 may be customized. For example, the arrangement of the one or more reagents in the indicator 140 may be configured to produce a customized response when exposed to an authentic product, and to produce a different customized response when exposed to a counterfeit product.

In one specific example, the regions 160 of the indicator 140 may be configured to produce a discernible pattern in response to exposure to an authentic product (FIG. 3A), and to produce a somewhat altered image in response to exposure to a counterfeit product (FIG. 3B). The one or more reagents in the indicator 140 also may be arranged and/or formulated so that the same indicator can be used to indicate whether or not multiple different products are authentic or counterfeit.

The anti-counterfeit indicator 40 may be permanently or removably carried by the container 20.

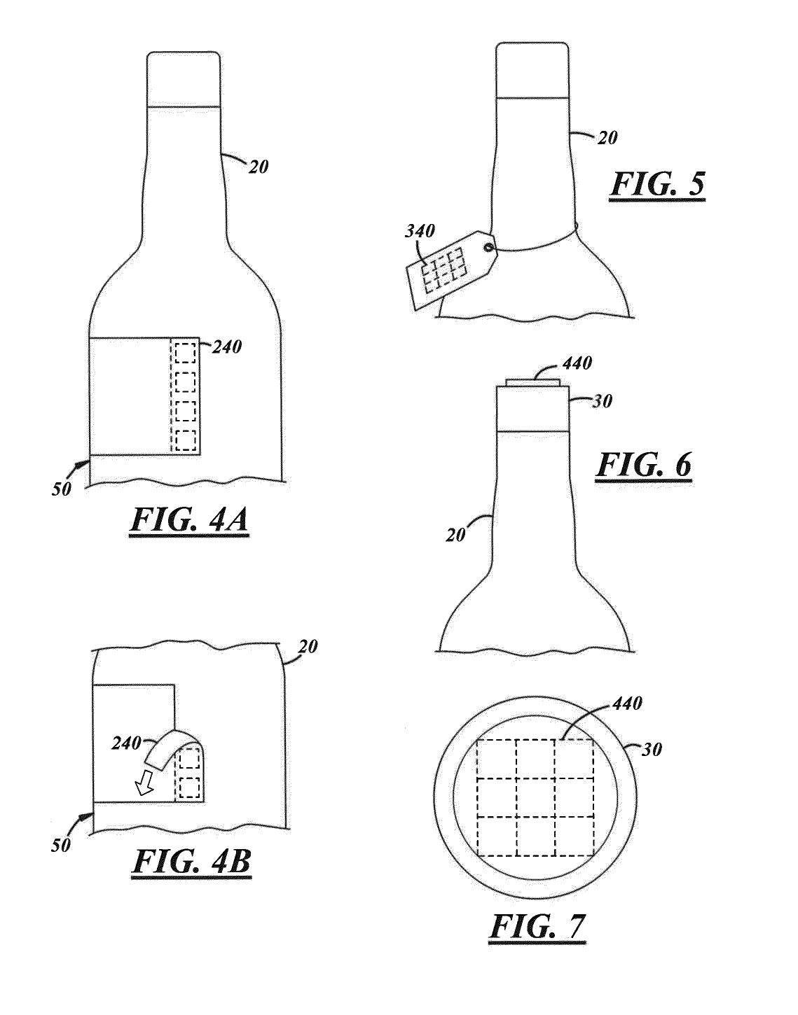

FIGS. 4A and 4B show another illustrative embodiment of an anti-counterfeit indicator 240. In this embodiment, the anti-counterfeit indicator 240 is formed on the external surface 50 of the container 20 such that it can be peeled away and removed from the container 20, if desired. It may be desirable to remove the indicator 240 from the container 20, for example, so that the indicator can more easily be exposed to a sample of the product within the container. As shown, the indicator 240 may be attached to the container 20 as part of a unitary label, which may be perforated to allow the indicator portion of the label to be separated from the remaining portion of the label. In the embodiment shown in FIG. 5, the indicator 340 is formed as part of a hangtag, which may be configured to hang around the neck of the container 20. This embodiment allows the indicator 340 to be initially carried by the container 20, but later separated from the container 20 without altering the physical condition of the container or any of the labels.

In some embodiments, the anti-counterfeit indicator 40 may be carried by the closure 30 of the package 10, instead of or in addition to the container 20.

In the embodiment illustrated in FIGS. 6 and 7, an anti-counterfeit indicator 440 is carried on top of the closure 30. In this configuration, the closure 30 may be removed from the container 20, inverted, and then inserted back into the container 20 so that the indicator 440 on the top of the closure 30 can be exposed to the product without removing a sample of the product from the container 20. In other embodiments, an indicator may be carried on a surface of the closure 30 that faces the interior of the container 20 such that the indicator can be exposed to the product by simply inverting the container 20, without opening the container or removing the closure 30. Thereafter, the container 20 may be opened and the closure 30 removed to reveal the response produced by the indicator.

The anti-counterfeit indicator 40 of the present disclosure can be used to indicate whether a variety of different types of products dispensably disposed within containers are authentic or counterfeit. For example, the anti-counterfeit indicator 40 can be used to establish the authenticity of fine wine or liquor.

In one embodiment, the indicator 40 may be formulated to establish the authenticity of a wine or liquor product by indicating whether or not certain “signature” chemical compounds are present in the product, and/or if the signature chemical compounds are present in appropriate amounts. Examples of “signature” chemical compounds in products include flavor compounds, e.g., alcohol or phenol compounds. A suitable enzyme for detecting the presence of alcohol in a product is alcohol oxidase, and a suitable enzyme for detecting the presence of phenol compounds in a product is tyrosinase.

In another embodiment, the indicator 40 may be formulated to indicate the overall flavor profile of one or more products. In such case, the indicator 40 may include several reagents, with each reagent being indicative of a certain chemical compound in a product. Since different products necessarily have different compositions and thus different flavor profiles, a different response may be anticipated for each product using the same indicator.

There thus has bees disclosed a package with an anti-counterfeit indicator for indicating whether or not a product dispensably disposed within a container is authentic, that fully satisfies one or more of the objects and aims previously set forth. The disclosure has been presented in conjunction with several illustrative embodiments, and additional modifications and variations have been discussed. Other modifications and variations readily will suggest themselves to persons of ordinary skill in the art in view of the foregoing discussion. For example, the subject matter of each of the embodiments is hereby incorporated by reference into each of the other embodiments, for expedience. The disclosure is intended to embrace ail such modifications and variations as fall within the spirit and broad scope of the appended claims.

1. A package that includes:
a container,
a product dispensably disposed within said container,
a closure for said container, and
an indicator carried by said container, said closure, or both said container and said closure, wherein said indicators indicates whether or not said product within said container is authentic or counterfeit when said indicator is exposed to a sample of said product.

2. The package as set forth in claim 1 wherein said indicator produces a response when said indicator detects the presence of a predetermined chemical compound in said product.

3. The package as set forth in claim 1 wherein said indicator produces a response when said indicator detects the presence of a chemical compound in said product that is known to be associated with an authentic product.

4. The package as set forth in claim 1 wherein said indicator produces a response when it detects the presence of a chemical compound in said product that has not been added to said product for identification or authentication purposes.

5. The package as set forth in claim 1 wherein said indicator produces a response that can be observed or detected without using an instrument.

6. The package as set forth in claim 1 wherein said indicator produces a colorimetric response or a fluorescence response.

7. The package as set forth in claim 1 wherein said indicator includes a reagent that reacts with a chemical compound in said product to produce a response.

8. The package as set forth is claim 1 wherein said indicator is removably carried by said container, said closure, or both said container and said closure.

9. The package as set forth in claim 1 wherein said indicator is carried by an external surface of said container.

10. The package as set forth in claim 1 wherein said indicator is in the form of a sol-gel coating.

11. A method of authenticating a product dispensably disposed within a container that includes:
(a) identifying a chemical compound associated with an authentic product,
(b) providing a sample of said product,
(c) exposing an indicator to said sample of said product,
(d) detecting said chemical compound in said sample, and
(e) observing a response produced by said indicator.

12. The method as set forth in claim 11 that also includes:
after said step (e), comparing said response to a reference.

13. The method as set forth in claim 11 wherein said step (b) includes removing a sample of said product from said container.

14. The method as set forth in claim 11 wherein said step (c) includes wetting said indicator with said sample of said product.

15. The method as set forth in claim 11 wherein said step (d) includes reacting a reagent with said chemical compound in said sample.

16. The method as set forth in claim 11 wherein said step (e) includes observing a colorimetric response or fluorescence response by said indicator.

17. The method as set forth in claim 11 that also includes:
before said step (c), removing said indicator from said container.

18. The method as set forth in claim 11 wherein said step (c) further deludes inverting said container.

19. A method of determining whether a product dispensably disposed within a container is authentic or counterfeit that includes:
(a) removing a sample of said product from said container,
(b) applying said sample to an indicator carried on an external surface of said container or on a closure of said container, and
(c) detecting a chemical compound in said sample that is associated with an authentic product.

20. The method as set forth in claim 19 that also includes:
observing a response indicating the detection of said chemical compound in said step (c).
